(19) United States
(12) Patent Application Publication
(10) Pub. No.: US 2011/0260473 A1
(43) Pub. Date: Oct. 27, 2011

(54) METHOD FOR STANDBY GENERATOR RESTART AFTER FAULT SHUT-DOWN

(75) Inventors: Brandon M. Batzler, Hartford, WI (US); Kenny J. Stair, North Prairie, WI (US)

(73) Assignee: BRIGGS & STRATTON CORPORATION, Wauwatosa, WI (US)

(21) Appl. No.: 12/768,163

(22) Filed: Apr. 27, 2010

(51) Int. Cl. H02P 9/04

(52) U.S. Cl. 290/40 C

(57) ABSTRACT

A standby generator that includes a control unit that allows the standby generator to be automatically restarted upon termination of the generator operation due to a fault condition. The control unit of the standby generator monitors various conditions of the standby generator and terminates operation of the standby generator upon detection of any one of a plurality of fault conditions. After the generator operation has been terminated, the control unit determines whether the fault condition is one of a series of fault conditions that allows automatic restarting. If the fault condition allows for automatic restarting, the control unit monitors the status of the generator and will automatically restart the generator after removal of the fault condition.

### BACKGROUND OF THE INVENTION

The present disclosure generally relates to a system and method for operating a standby generator. More specifically, the present disclosure relates to a method and system for automatically restarting a standby generator after one or more selected fault conditions cause the generator to automatically shut down.

When there is a residential power outage, backup power may be provided to a residence by a standby generator. In some cases, the standby generator is started automatically after detection of the power outage. A standby generator that is started automatically usually requires an automatic transfer switch to connect electrical loads within the residence to the generator rather than to the power supply in the home. A combination of a standby generator and an automatic transfer switch is generally installed in the residence by trained personnel.

Since the power supply by the standby generator is limited by the size of the generator, the amperage rating of the generator can limit the types of and number of appliances that are connected to the standby generator during power outages. As an example, large appliances such as air conditioners, hot water heaters and on-demand appliances such as microwave ovens and toasters can draw a significant amount of power that in combination may exceed the rating limit for the standby generator.

Since standby generators may need to run for an extended period of time during a power outage, standby generators typically include some type of generator monitoring system. The generator monitoring system is equipped with sensors that detect operating conditions of the standby generator and shut down the generator in the event of potentially damaging conditions, such as low oil pressure, high engine temperature, engine overspeed and other fault conditions.

In currently available systems, when the generator is shut down due to a sensed fault condition, the standby generator must be manually restarted by the generator owner or maintenance personnel at the generator. Thus, if the engine automatically shuts down due to a fault condition, the generator can only be restarted by a manual activation at the generator. Most owners are not comfortable manually restarting the generator and thus make a service call to a trained technician, which results in a power interruption until the technician arrives.

### SUMMARY OF THE INVENTION

The present disclosure generally relates to a system and method for operating a standby generator and automatically restarting the generator after detection of one or more select fault conditions.

The standby generator includes a control unit that receives various inputs from the generator relating to operation of the generator. These inputs can include a battery voltage input, an oil temperature input, an oil pressure input and connections to the output of the generator. The control unit of the standby generator monitors for the loss of electric power in a residence. Upon detection of the loss of electric power, the control unit begins operation of the internal combustion engine of the generator.

During operation of the generator, the control unit monitors for any one of a plurality of generator fault conditions. These fault conditions can include low oil pressure, low battery voltage, low generator voltage, the failure to start the generator, a low frequency output, engine overspeed and other fault indicators.

When the control unit senses one of the fault conditions, the control unit terminates operation of the generator. After the operation of the generator has been terminated, the control unit determines whether the detected fault condition is one of a select series of fault conditions that allows the control unit to automatically restart the generator. If the fault condition does not meet one of these restart conditions, the generator remains in the turned-off condition.

However, if the control unit determines that the fault condition meets one of the fault conditions that allow restarting, the control unit will automatically restart the generator when the fault condition is removed. Preferably, the control unit will wait for a delay period before determining whether the fault condition has been removed. If the fault condition no longer exists, the control unit will automatically restart the standby generator without requiring any manual input. In this manner, the control unit can restart the generator without requiring the owner/installer to manually reset the fault condition at the standby generator.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a schematic illustration of a residential electrical system having a load management system and a standby generator;

FIG. 2 is a perspective view of the standby generator;

FIG. 3 is a view of the display panel of the standby generator;

FIG. 4 is a circuit schematic illustrating the configuration of the standby generator control unit; and

FIG. 5 is a flowchart illustrating the process carried out by the generator control unit in restarting the generator after a fault condition.

### DETAILED DESCRIPTION OF THE INVENTION

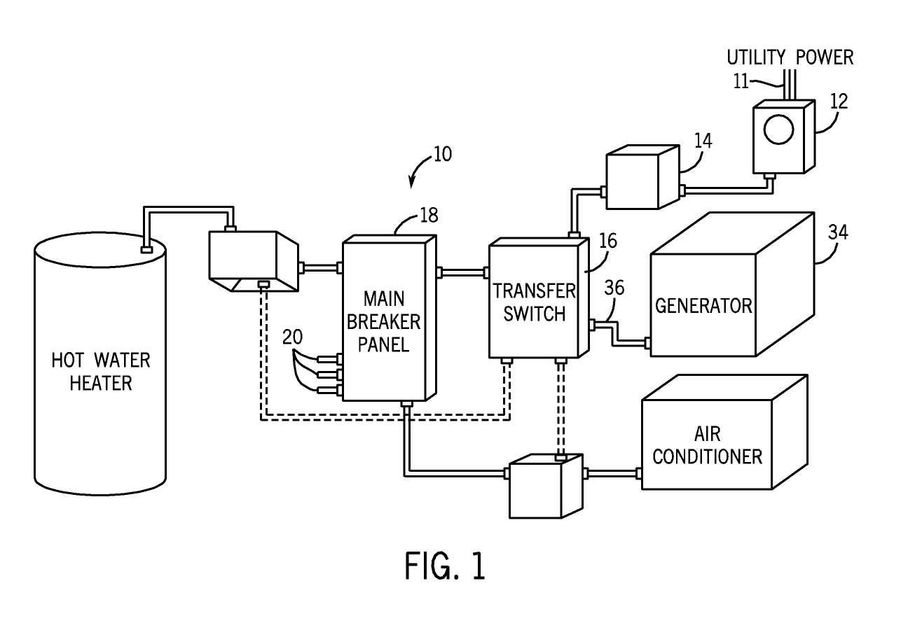

FIG. 1 depicts a load management system 10 used in a residence. The load management system 10 includes a connection to a main power supply 11 through a meter 12. The power supply from the meter 12 is fed through an optional service disconnect switch 14 to a transfer switch 16. The transfer switch 16 carries out a series of functions, as will be described below and can also be referred to as a load-management controller. Throughout the following disclosure, the term “transfer switch” will be utilized with the understanding that the transfer switch 16 could also be referred to as a load-management device.

The transfer switch 16 feeds electrical power to a main breaker panel 18 for the residence. The main breaker panel 18 includes a series of individual branch circuits 20 to provide electrical power to normal loads included in a residence, such as the lights, power outlets, etc.

The transfer switch 16 is connected to a standby generator 34 through connection 36. As is well known, when the supply of power from the utility is interrupted, a control unit within the transfer switch 16 senses the interruption of power. The transfer switch 16 sends a signal to turn on the standby generator 34 and controls switches in the transfer switch 16 to direct the supply of electricity generated by the standby generator 34 to the main breaker panel 18. When the connection is made between the generator 34 and the main breaker panel 18, the connection between the utility power supply 11 and the main breaker panel 18 is disrupted such that electricity is supplied only by the standby generator 34.

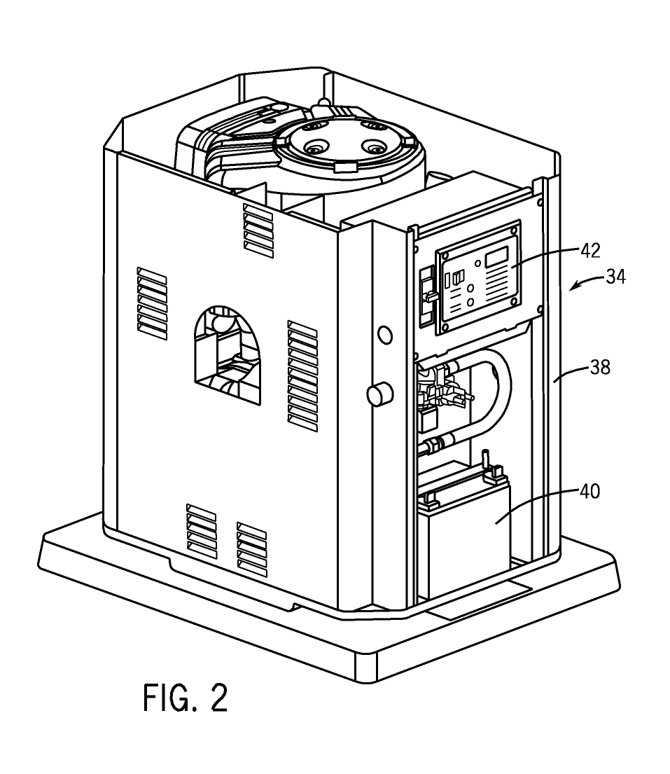

FIG. 2 illustrates one embodiment of a standby generator of the present disclosure. In the exemplary embodiment shown, the standby generator 34 is a 10 KW home generator system, although other standby generators could be used. The standby generator 34 includes an internal combustion engine that can be operated using either natural gas or liquid propane.

As illustrated in FIG. 2, the standby generator 34 includes an outer housing 38 that encloses the operating components of the standby generator, including a 12-volt DC battery 40. The battery 40 provides the required power to start the internal combustion engine.

The standby generator 34 includes a control panel 42 that allows an operator to conduct various tests, monitor the operation of the generator and perform various maintenance functions for the standby generator. The control panel 42 is connected to a control unit for the standby generator such that the control unit can relay messages to an owner/operator and receive input commands through the control panel 42.

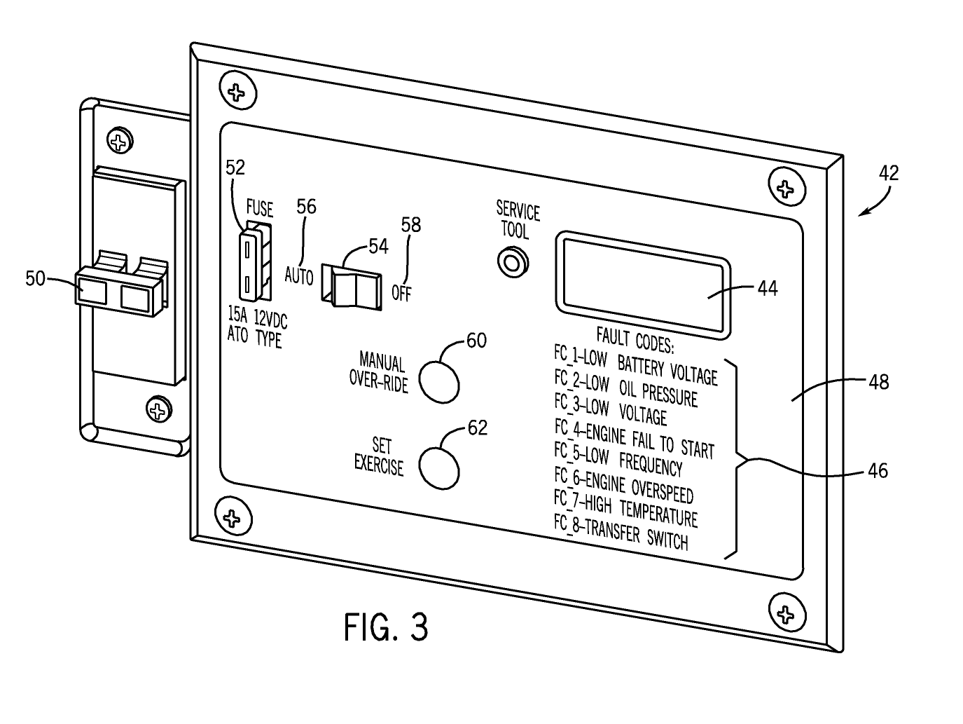

FIG. 3 is a magnified view of the control panel 42. The control panel 42 includes a digital display 44 that allows the control unit of the standby generator to display the total number of hours the generator has been running and various fault codes. The digital display 44 is also used to schedule maintenance tasks and for trouble shooting operational problems within the standby generator. A list 46 of fault codes is printed on the face surface 48 such that an operator can determine the type of fault that has occurred within the generator based upon the fault code shown on the digital display 44.

Control panel 42 further includes a circuit breaker 50 that protects the standby generator from shorts and other overcurrent conditions. The circuit breaker 50 must be in the “on” position to supply power to the transfer switch 16 shown in FIG. 1. A fuse 52 is contained within the control panel 42 to protect the standby generator DC control circuits contained within the control unit.

The control panel 42 includes a system switch 54 that allows the operator to manually control the operation of the standby generator. When the system switch 54 is in the “auto” position 56, the control unit of the standby generator can automatically start operation of the generator upon a utility power outage. When utility power is restored, the transfer switch sends a signal to the standby generator control unit which automatically shuts off the standby generator and waits for the next utility power outage.

When the system switch 54 is in the “off” position 58, the control unit turns off the generator and prevents the generator from starting until the system switch is returned to the “auto” position 56.

In the embodiment shown in FIG. 3, the control panel 42 further includes a manual override switch 60. When the system switch 54 is in the “auto” position 56, an operator can depress the manual override switch 60 to start the generator. To turn off the generator after starting, the manual override switch 60 is again depressed until the engine stops. In the embodiment illustrated, the manual override switch 60 is a push button switch.

The control panel 42 further includes a set/exercise switch 62 that allows the operator to set the exercise cycle start time and day of the week.

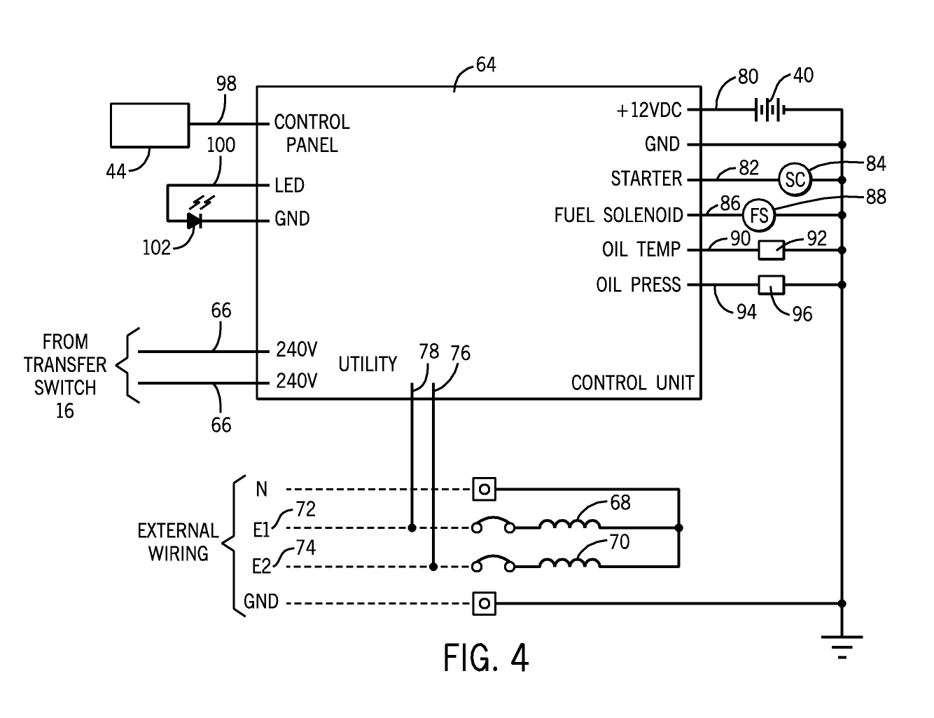

FIG. 4 schematically illustrates the control unit 64 for the standby generator. The control unit 64 can be various different types of processors while operating within the scope of the present disclosure. Although a single control unit 64 is shown in FIG. 4, it should be understood that the control unit could be formed from multiple control units joined together in an operating condition.

The control unit 64 includes a series of inputs that allows the control unit 64 to sense various operating conditions of the standby generator. The control unit 64 is programmed with various operating instructions that allow the control unit 64 to control the operation of the standby generator based upon the various different inputs received in the manner to be described

The control unit 64 includes a pair of inputs 66 from the transfer switch 16. The inputs 66 allow the control unit 64 to monitor the voltage from the utility. If the voltage from the utility disappears from the inputs 66, the control unit 64 determines that the utility power has been disrupted and the control unit 64 begins the process of starting the standby generator.

The standby generator includes a pair of power windings 68, 70 that, when the standby generator is operating, create a voltage source at a pair of voltage outputs 72, 74. The control unit 64 monitors the voltage at each of the outputs 72, 74 through a pair of generator inputs 76, 78. Through the generator inputs 76, 78, the control unit can monitor various generator parameters, such as the generator voltage and the generator frequency.

The control unit 64 includes a battery voltage input 80 that is connected to the battery 40. A starter output 82 is connected to contacts 84 of the starter. The control unit 64 controls starting of the internal combustion engine through the starter output 82 and the contacts 84. A fuel solenoid output 86 is connected to a fuel solenoid 88, which provides another method for the control unit to control operation of the standby generator.

The control unit includes an oil temperature input 90 that receives an input from an oil temperature switch 92 which allows the control unit 64 to monitor oil temperature within the standby generator. An oil pressure input 94 allows the control unit 64 to monitor the status of an oil pressure switch 96.

The control unit 64 includes a status output 98 that is shown connected to the display 44. The control unit 64 can display messages on the display 44 through the status output 98.

The control unit 64 includes a status indicator output 100 that is connected to an indicator LED 102. The status indicator output 100 allows the control unit 64 to blink the LED 102 in a pattern to indicate the type of fault that has been sensed by the control unit 64.

The various types of faults that can be detected by the control unit 64 are shown by the fault codes 46 shown in FIG. 3. In the embodiment illustrated, the control unit 64 can generate eight separate fault codes, although it is contemplated that the control unit 64 could be programmed to detect various other faults depending upon the configuration of the standby generator. Each of the individual fault codes will now be described.

Fault code FC_1 represents a low battery voltage condition and is indicated by a single blink of the LED indictor 102. To detect this fault code, the control unit 64 monitors the voltage at the battery voltage input 80 and generates the fault code if the battery voltage falls beneath the required battery output voltage required to crank the internal combustion engine of the standby generator. This fault condition may be caused by a faulty battery or a faulty battery charge circuit. When this fault condition is sensed, the control unit 64 terminates operation of the generator and generates fault code FC_1 on the display 44.

The second fault condition, low oil pressure, is indicated by fault code FC_2 and two blinks of the remote LED indicator 102. As shown in FIG. 4, the system includes an oil pressure switch 96 connected to the oil pressure input 94. If the oil pressure drops below a pre-determined value, the switch contacts close and the control unit 64 senses the low oil pressure at input 94. Upon sensing the low oil pressure, the control unit 64 terminates operation of the generator and generates fault code FC_2 on the digital display 44.

The third fault code, FC_3, represents a low voltage fault for the generator. This low voltage condition is sensed by the control unit 64 through the generator input lines 76 and 78. The low voltage condition may be caused by a restriction in the fuel flow, a broken or disconnected signal lead, a failed alternator winding, an open breaker on the control panel or an overload condition on the generator. The control unit 64 discontinues operation of the internal combustion engine upon the low voltage detection and displays the fault code FC_3 on the display 44.

The fourth fault code, FC_4, represents the failure of the engine to start after a predetermined number of attempts by the control unit 64 through the starter contacts 84. Each time the standby generator is directed to start, the control unit 64 will close the starter contacts 84 for a pre-determined cycle and repeats the cycle if the engine does not start. If the standby generator does not begin producing electricity after a number of unsuccessful cycles, the unit will stop cranking and the control unit 64 will flash the indicator LED 102 four times and display the fault code FC_4 on the display 44.

Fault code FC_5 provides an indication of a low frequency output of the standby generator. The frequency of the generator output is again determined through the generator inputs 76, 78. The control unit 64 shuts down the standby generator if the control unit 64 determines that the engine is running slower than a pre-determined frequency. Typically, this condition is caused by a failed engine governor or by excessive loads on the generator.

Fault code FC_6 relates to engine overspeed. The control unit 64 terminates operation of the standby generator upon an overspeed condition. This feature protects devices connected to the transfer switch by shutting the standby generator down if the engine runs faster than a preset limit. The overspeed fault is detected through the generator input 76, 78. If the generator output frequency is above a pre-determined level, the generator will shut down.

Fault code FC_7 is a high temperature fault detected by the control unit 64 through the oil temperature switch 92 and the oil temperature input 90. The oil temperature switch 92 is a normal open temperature switch. If the engine oil temperature exceeds a pre-determined temperature, the switch closes and the control unit 64 shuts down the operation of the standby generator. Common causes for this condition include running the unit with all access covers removed, an obstructed air inlet or exhaust port, low oil levels or debris in the engine cylinder cooling fins.

The final fault code FC_8 is a transfer switch fault, which may be most likely caused by a blown fuse in the transfer switch. Again, if the control unit 64 senses this fault, the control unit 64 shuts down operation of the standby generator.

As can be understood by the description of the eight fault codes shown on the control panel 42 of FIG. 3, the control unit 64 of the standby generator immediately stops operation of the standby generator upon detecting any one of the eight fault codes. In previous standby generator operating systems, the standby generator would remain in the off condition until the owner of the generator or a certified installer manually reset the control unit 64 through the system switch 64 shown in FIG. 3. However, in accordance with the present disclosure, the control unit 64 is able to automatically restart the standby generator after receiving one of a series of select fault codes following a delay period and depending upon which type of fault code was received by the control unit 64.

As an illustrative example, the generator control unit 64 is programmed such that the control unit 64 is able to automatically restart the internal combustion engine of the standby generator after a delay period following the low voltage fault (FC_3), the low frequency fault (FC_5), the engine overspeed fault (FC_6) and the high temperature (FC_7) fault. In such situations, the control unit 64 will automatically restart the internal combustion engine after a delay period without requiring any operator or service personnel to manually reset the generator control panel. Although the generator control unit 64 can automatically restart the generator upon receiving one of the faults identified above, it is contemplated that the control unit 64 would not automatically restart the generator upon the low battery voltage fault (FC_1), low oil pressure fault (FC_2), failure to start fault (FC_4) and the transfer switch fault (FC_8). Each of these faults may be an indicator of conditions existing at the generator that require further review and action by either the owner or trained personnel.

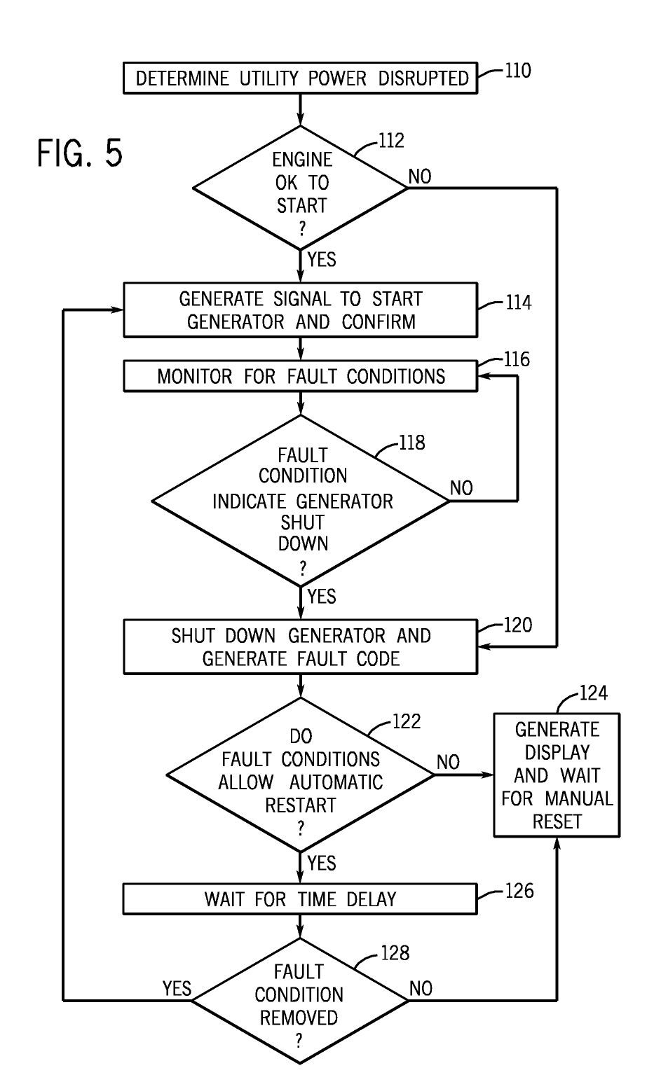

Referring now to FIG. 5, the operating sequence carried out by the control unit 64 will now be described. Initially, the control unit 64 determines in step 110 that the utility power has been disrupted for any one of a variety of reasons. Once the control unit 64 determines that power has been disrupted, the control unit checks all of the relevant inputs and determines whether any fault conditions exist in step 112. If the engine is okay to start, the control unit 64 generates a signal to the starter in step 114 and confirms that the generator has begun operation.

Once the generator begins operation, the control unit 64 monitors for fault conditions in step 116. In step 118, the control unit determines whether any fault conditions exist that indicate that the generator should shut down. If no fault conditions exist, the system returns to step 116 and continues to monitor for fault conditions.

However, if in step 118 the control unit determines that a fault condition exists, the control unit shuts down the generator and generates the appropriate fault code, as indicated by step 120.

After the generator has been shut down, the control unit determines in step 122 whether the generator was shut down based upon a fault condition that would allow an automatic restart. As indicated previously, several faults, such as load generator voltage, low generator frequency, engine overspeed and overtemperature will allow the control unit 64 to automatically restart the engine after a delay period. If the control unit determine in step 122 that the fault was not one of the faults that allows restart, the control unit proceeds to step 124 and waits for a manual restart by trained personnel. As indicated previously, fault conditions such as low battery voltage, low oil pressure, the failure of the engine to start after a predetermined period and a transfer switch fault will not allow for automatic restarting by the control unit.

If the system determines in step 122 that the fault condition allows for an automatic restart, the system moves to step 126 and begins a delay timer. As an illustrative example, if the fault condition was due to a high temperature detected by the temperature switch 92, the control unit 64 may wait for a delay period, such as 2-5 minutes. After the expiration of the delay period in step 126, the system monitors for whether the fault condition has been removed in step 128. As an example, after the delay period of step 126, the temperature switch 92 may return to the normally closed condition, which indicates that the engine temperature has fallen to a safe level. If the system determines in step 128 that the fault condition has been cleared, the system attempts to automatically restart the standby generator in step 114. However, if the fault condition is not removed in step 128, the system returns to step 124 and generates the fault code and waits for a service call before the generator is manually restarted.

As can be understood by the above description, the engine control unit 64 of the standby generator allows the standby generator to automatically restart following a delay period depending upon the type of fault condition that existed to initially disrupt operation of the standby generator. Various different fault conditions are described above that allow for he automatic restart. However, it should be understood that the control unit 64 could be programmed to automatically start on various other fault conditions depending upon the configuration of the standby generator.

Additionally, although a delay period was described for one type of fault condition, it should be understood that different delay periods could be utilized depending upon the individual fault codes. As an example, the delay period following shut down due to a low voltage from the generator may be longer to allow various loads to be removed from the generator within the residence.

We claim:

1. A method of operating a standby generator, comprising:
monitoring for the loss of electric power in a residence;
automatically starting the generator upon loss of electric power;
monitoring for any one of a plurality of generator fault conditions;
terminating operation of the generator upon detection of any of the plurality of generator fault conditions;
determining whether the detected fault condition meets a series of restart conditions; and
automatically restarting the generator if the detected fault condition meets the series of restart conditions.

2. The method of claim 1 further comprising the step of generating a start signal to the generator to begin operation of the generator after detection of the loss of electric power.

3. The method of claim 2 wherein the start signal is generated by a transfer switch positioned between the generator and the supply of electric power in the residence.

4. The method of claim 3 wherein the transfer switch generates the start signal upon loss of power and connects the generator to the residence.

5. The method of claim 1 wherein one of the restart conditions is the expiration of a delay period following termination of generator operation.

6. The method of claim 1 wherein the step of determining whether the fault condition meets the series of restart conditions is made within a control unit of the generator.

7. The method of claim 6 further comprising the step of displaying the fault condition that causes the termination of the generator operation.

8. The method of claim 6 wherein the control unit of the generator automatically restarts the generator.

9. The method of claim 8 wherein the control unit prevents automatic restart of the engine when the fault conditions do not meet the restart conditions.

10. The method of claim 1 wherein one of the series of restart conditions is the type of fault condition.

11. The method of claim 10 wherein the type of fault that allows automatic generator restart include the detected voltage frequency outside of predefined limits and generator temperature above a pre-set limit.

12. The method of claim 10 wherein an additional one of the series of restart conditions is the expiration of a delay period following termination of the generator operation.

13. The method of claim 12 wherein the step of determining whether the fault condition meets the series of restart conditions is made within a control unit of the generator.

14. A method of operating a standby generator that provides electric power to a residence, comprising:
monitoring for the loss of electric power a control unit of the standby generator;
generating a start signal from the control unit to begin operation of the generator;
monitoring for any one of a plurality of generator fault conditions in the control unit of the generator;
terminating operation of the generator upon detection of any one of the plurality of generator fault conditions;
determining whether the detected generator fault condition allows restarting of the generator; and
automatically restarting the generator if the detected fault condition allows restarting.

15. The method of claim 14 wherein the step of determining whether the detected generator fault condition allows restarting of the generator includes comparing the detected fault condition to a series of select generator fault conditions that allows restarting in the control unit.

16. The method of claim 14 wherein the generator is automatically restarted after a delay period when the detected generator fault condition is eliminated.

17. The method of claim 15 wherein the generator fault conditions that allow restarting include the detection of a voltage frequency outside of a predefined limit and the detection of generator temperature above a pre-set limit.

18. The method of claim 14 wherein the control unit prevents automatic restarting of the generator when the detected generator fault condition is not one of the conditions that allows restarting.
